(19) United States
(12) Patent Application Publication
(10) Pub. No.: US 2024/0086809 A1
(43) Pub. Date: Mar. 14, 2024

(54) Process Variation Management

(71) Applicant: Nintex UK Ltd., London (GB)

(72) Inventors: Dmitry Shuvaev, London (GB); Kerry Hiki, London (GB); Mark Whooley, London (GB); Olivia Labattaglia, London (GB); Shaun Field, London (GB)

(73) Assignee: Nintex UK Ltd., London (GB)

(21) Appl. No.: 17/943,084

(22) Filed: Sep. 12, 2022

(51) Int. Cl. G06Q 10/06; G06Q 10/10

(52) U.S. Cl. CPC G06Q 10/06316; G06Q 10/103

(57) ABSTRACT

Systems, methods, and devices for implementing and managing process variations by, for example: comparing a first business process with a second business process; presenting, based at least in part on the comparing, an option to incorporate the at least one feature into the second business process; receiving, based at least in part on the presenting, approval or rejection of the option to incorporate the at least one feature into the second business process; and incorporating or refraining from incorporating, based at least in part on the receiving, the at least one feature into the second business process.

### FIELD OF USE

The present disclosure relates generally to the field of network processes and associated tasks. More specifically, the present disclosure relates to systems, methods, and processes for incorporating and managing changes in activities of business processes.

### BACKGROUND

Business processes are vitally important parts of businesses. Business processes impact customer experiences, the use of products and services, revenue, operational efficiency, etc.

A “business process” may involve related events, activities, decisions, actors, and objects that result in an outcome. Such processes help determine tasks, activities, responsibilities, and how these are carried out.

Globalization, standardization, and the push for a competitive edge have demanded efficient business processes. This demand is hard to satisfy due to a lack of understanding and appreciation of business processes generally, and to inadequate associated technologies.

One such technology is a workflow management system (WfM) (known in some cases as well as a Business Process Management System (BPM)). WfMs use process models to assist in creating and managing “workflows.” Workflows may relate to applications and systems that streamline and/or automate a wide variety of processes, enhancing productivity and efficiency.

Tasks (e.g., pieces of work to be done) are core components of workflows. Within workflows, a task may be completed electronically by another system or human, either manually or automatically. For example, processes related to workflows that involve tasks may include collecting signatures, gathering feedback, requesting approvals for a plan or document, tracking the current status of a business procedure, etc.

While WfMs may implement changes to business processes more easily than rewriting voluminous code inside complex software systems, such changes are extremely limited (to, for example, simply changing the order in which steps are performed).

Relatedly, process architectures provide a representation of processes and their interrelations as they exist in an organization. Thus, process architectures may serve as a framework for defining priorities and the scope of process modeling and redesign projects. However, existing process architectures also often fail to represent or account for the needed complexity of organization's business processes and changes thereto.

Thus, what is needed are systems, methods, and processes for systems that enable users to create, address, and manage business processes, and changes thereto, through various new means.

### SUMMARY OF THE DISCLOSURE

The following presents a simplified overview of example embodiments in order to provide a basic understanding of some aspects of the invention. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented herein below. It is to be understood that both the following general description and the following detailed description are exemplary and explanatory only and are not restrictive.

Embodiments of this disclosure provide a system, method, and process that improves use of a computer system and other computer systems to implement business process variations. Embodiments also include the collaborative development of systems that improve the interaction between various components of computer systems and improve the efficiency of all computer processes, the cloud, and the Internet in general. Specifically, embodiments of the disclosure provide a framework for implementing business process variations within various technology such as workflow processes, workflow designers, and WfMs; thus improving utilization of electronic devices and increasing the efficiency of the completion of tasks associated with the use of the electronic devices.

In accordance with the embodiments disclosed herein, the present disclosure relates to systems, methods, and processes for managing process variations. In one example, the disclosure describes a computing device, which includes a processor, a memory, and a non-transitory, computer-readable medium operably coupled to the processor. The computer-readable medium may have computer-readable instructions stored thereon that, when executed by the processor, cause the computing device to compare a first business process with a second business process, wherein the first business process includes at least one feature omitted from the second business process. The computer-readable instructions may also cause the computing device to present, based at least in part on the comparing, an option to incorporate the at least one feature into the second business process. The computer-readable instructions may also cause the computing device to receive, based at least in part on the presenting, approval, or rejection of the option to incorporate the at least one feature into the second business process. The computer-readable instructions may also cause the computing device to incorporate or refrain from incorporating, based at least in part on the receiving, the at least one feature into the second business process.

In another example, the disclosure describes a method for selectively incorporating changes into business processes. In some embodiments, the method may include comparing a first business process with a second business process, wherein the first business process includes at least one feature omitted from the second business process. In some embodiments, the method may further include presenting, based at least in part on the comparing, an option to incorporate the at least one feature into the second business process. In some embodiments, the method may also include receiving, based at least in part on the presenting, approval or rejection of the option to incorporate the at least one feature into the second business process. In addition, in some embodiments, the method may include incorporating or refraining from incorporating, based at least in part on the receiving, the at least one feature into the second business process.

In another example, the disclosure describes a non-transitory, computer-readable medium having stored thereon computer-readable instructions. In some embodiments, when executed by a computing device, the computer-readable instructions may cause the computing device to compare a first business process with a second business process, wherein the first business process includes at least one feature omitted from the second business process. In some embodiments, when executed by a computing device, the computer-readable instructions may cause the computing device to present, based at least in part on the comparing, an option to incorporate the at least one feature into the second business process. In some embodiments, when executed by a computing device, the computer-readable instructions may cause the computing device to receive, based at least in part on the presenting, approval or rejection of the option to incorporate the at least one feature into the second business process. In some embodiments, when executed by a computing device, the computer-readable instructions may cause the computing device to incorporate or refrain from incorporating, based at least in part on the receiving, the at least one feature into the second business process.

Still other advantages, embodiments, and features of the subject disclosure will become readily apparent to those of ordinary skill in the art from the following description wherein there is shown and described a preferred embodiment of the present disclosure, simply by way of illustration of one of the modes best suited to carry out the subject disclosure. As will be realized, the present disclosure is capable of other different embodiments and its several details are capable of modifications in various other embodiments all without departing from, or limiting, the scope herein.

### BRIEF DESCRIPTION OF THE DRAWINGS

The accompanying drawings, which are incorporated in and constitute a part of this specification, illustrate embodiments of the disclosure and together with the general description of the disclosure given above and the detailed description of the drawings given below, serve to explain the principles of the disclosure. In certain instances, details that are not necessary for an understanding of the disclosure or that render other details difficult to perceive may have been omitted.

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

FIG. 1 is a block diagram generally illustrating an embodiment associated with business process variations, in accordance with aspects of the disclosure.

FIG. 2 is a functional flow diagram generally illustrating an embodiment associated with setting up a business process variation, in accordance with aspects of the disclosure.

FIG. 3 is a block diagram generally illustrating an embodiment associated with assigning experts to business process variations, in accordance with aspects of the disclosure.

FIG. 4 is a block diagram generally illustrating an embodiment associated with controls for a business process variation, in accordance with aspects of the disclosure.

FIG. 5 is a block diagram generally illustrating an embodiment associated with comparing business process variations, in accordance with aspects of the disclosure.

FIG. 6 is a block diagram generally illustrating an embodiment associated with linking business process variations or features thereof, and incorporating features of a business process variation, in accordance with aspects of the disclosure.

FIG. 7 is a block diagram generally illustrating an embodiment associated with parallel activities of business process variations, in accordance with aspects of the disclosure.

FIG. 8 is a block diagram generally illustrating an embodiment associated with deleting and replacing activities of business process variations, in accordance with aspects of the disclosure.

FIG. 9 is a block diagram generally illustrating an embodiment of an electronic device system for processing business variations.

FIG. 10 is a flow diagram generally illustrating a method of selectively incorporating changes into business process variations, in accordance with aspects of the disclosure.

### DETAILED DESCRIPTION OF EMBODIMENTS

Before the present systems and methods are disclosed and described, it is to be understood that the systems and methods are not limited to specific methods, specific components, or to particular implementations. It is also to be understood that the terminology used herein is for the purpose of describing particular embodiments only and is not intended to be limiting. Various embodiments are described with reference to the drawings. In the following description, for purposes of explanation, numerous specific details are set forth in order to provide a thorough understanding of one or more embodiments. It may be evident, however, that the various embodiments may be practiced without these specific details. In other instances, well-known structures and devices are shown in block diagram form to facilitate describing these embodiments.

This disclosure relates to improving business process designing and management, in particular to management of business process variations—e.g., management of similar business processes with differences in details, such as in how the similar business processes are defined. There are many different types of business-process variations.

Global process variations are variations that are common across different types of processes. For example, processes might have variations for different regions, or variations for different customer types. Global process variations may vary across organization (e.g., a multi-national company) depending on location on the globe. For example, employees may request work-leave through an internal process, which might be affected by different laws in different countries. An associated global process variation may feature differences (e.g., in the forms, or in the amount of leave, or the conditions whereby leave may be granted) depending on applicable laws. Similarly, a process for handling job applications might involve different legal constraints in different countries. By way of additional example, different local governments may require different consents or permits as authorization to perform certain actions, such as starting or running a company or aspects thereof. By way of further example, price/cost brackets may vary according to global location. In some implementations, variations across an organization according to global location may be referred to as a variation category.

Other types of business process variations, such as process-specific (or “adhoc”) variations, may apply to only one process and are for processes that have unique variations.

Some business processes are “standard” processes (which may also be other types of processes like global). Some WfMs and similar architectures may be centered around standardized processes. In some examples, a standard can be shared by multiple processes within an organization. In such examples, one or more activities within the standard may be linked (as described in more detail below) to activities in other business processes related to the standard.

Accordingly, in such examples, when one change is made to the standard, the change may propagate to update process models that invoke the standard. More specifically, activities may be shared in common between the standard and other processes by, for example, placing the activities (with corresponding steps) into the process variations. If a shared activity is changed in the standard, in some examples, the change may be implemented in (e.g., “pushed and accepted” by) other activities or variations.

However, there is a lack of understanding generally as to how changes flow and/or are propagated from a standard to variations thereof. Contributing to this lack of understanding, some architectures do not make standard business processes visible along with variations. Accordingly, it may be desirable to see the variations between processes (whether or not permitting viewing a process termed a “standard” along with variations) to consider the business process variations in relation to one another to a greater degree previously possible in existing architectures. Accordingly, some embodiments contemplated herein may relate to viewing a standard business process in relation to process variations in a more holistic manner.

In some examples, a standard may often provide more details about components of its process, while variations may be somewhat simplified. Thus, viewing the standard may provide a reference tool that includes more comprehensive explanations about, for example, activities shared between the standard and the variations. In some examples, the extent to which a particular business process and related business processes are made visible may depend on the level of differences (if any) between processes. In some examples, when variations significantly vary from the standard, the standard's relevance may be diminished (as is the importance of its visibility). For instance, where variations are identical (or more or less the same), there may be less need for a visible standard and variations. However, some users may still desire that such very different variations stay linked together with the standard and therefore may wish to view the standard together with such variants.

In addition, some embodiments described below may offer certain advantages over a “standard-centered” business-processes model altogether. Such advantages may relate, for example, to viewing process variations without a standard (or central template), while still incorporating some benefits related to aspects of that model. That is, some examples described herein may not involve a “standard” process (e.g., a process with a higher hierarchical value, from which all variations can or must be derived) at all. Instead, some examples described herein may involve a variety of process variations that are considered equals, which may dynamically borrow process components, tasks, sub-tasks, activities, etc., from each other and which may be compared (e.g., in side-by-side views) to one another according to groups (e.g., or three or more process variations).

In some examples, a user may create or write or otherwise have a variation to which other variations may be compared, which in some embodiments may be on the same hierarchical level as the other variations. Such variations may be considered a variation set and, in some examples, may include some identical data or shared activities, or less significant differences with each other. Thus, some examples described herein may relate to such shared or standardized activities or tasks (rather than featuring a central template or standard process). For example, one or more of such shared activities may be selectively propagated throughout one or more selected variations, and otherwise managed between variations, which may then be referred to as shared variations.

In some examples, a user implementing a particular process variation may choose to accept or incorporate one or more activities or features of one or more other process variations within a variation set. As it may not always be desirable to incorporate changes into all other processes that invoke a particular process (whether or not a “standard”) without any approval or notice to users, in some examples, rather than “pushing” changes to other variations (as in some examples incorporating a standard process), changes (or activities of different variations or features thereof) may be dynamically “pulled” according to the instructions of different users associated with distinct process variations.

Thus, this disclosure relates to the concept of process variation management using shared activities. Common activities (and the steps they encapsulate) may be created and placed into process variations. In some embodiments, a user may identify and select activities that are or will be shared. For example, in some embodiments, activities may be dragged and dropped, or copied and pasted, within a graphical user interface from one variation into another variation (or, in standard-centered embodiments, from a standard into a variation, or vice versa), thus creating a “shared activity.” When activities are shared (or linked) between processes, changes to such activities may be tracked. As explained in more detail below, shared activities may also become unlinked.

In some embodiments, a change to the shared activity may trigger sending a request to ask if the change should be made in a related process variation. In some embodiments, all variations that incorporate a shared activity affected by a change will receive a notification (e.g., a push notification) requesting to accept or decline the update. Sometimes, an expert assigned to one variation will be uncertain if or how a change may impact other variations. Thus, to help explain such a potential impact, the user that initially makes a change may (and in some embodiments may be required) to provide detailed reasons for the change, which reasons may be sent for the review of other experts or other users using variations with the shared activities, to help decide for their variation if the update/change should be accepted or declined.

In any event, process variations as described herein may differ from one another at different process points (rather than all changes simply being propagated from the top of a process down). And how such variations diverge from one another may be visible, as described in this disclosure.

As mentioned above, some examples described herein, in addition or alternatively to comparing a business process variation to the standard, or to a previous version of the business process variation, may involve comparing separate business process variations to each other. Such visibility of different process variations (and potentially of standards) may result in benefits, such as providing insights as to efficiencies and on standardizing approaches. In some embodiments, changes to activities may be incorporated from one variation to another (e.g., the changes may be synced across variations).

In addition, such changes (incorporated into the standard from a variant) may then be propagated into or adopted by other business process variations in accordance with other aspects of this disclosure. For example, in some embodiments, updating a process variation (or in some embodiments, a standard process) may then request approval to propagate the changes (from the desirable variant). In such examples, therefore, not all variations would be required to adopt the changes.

In some embodiments, differences in a business process variation may also be incorporated into the standard. For example, it may be learned after use and analysis that a particular variant or activity is desirable above other variants or activities in the standard. Such desirability may be based, for instance, on a process of part therefore performing or accomplishing some objective. In some examples, such improved variants or activities may be merged into the standard from the variant as a change.

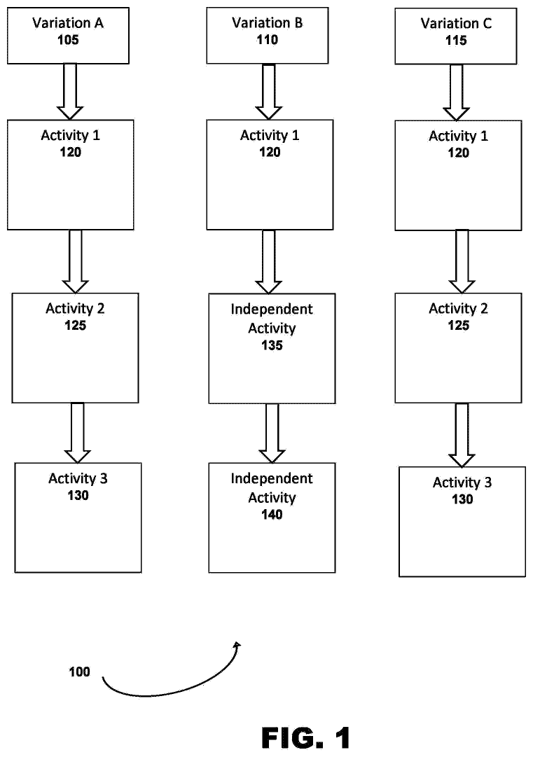

FIG. 1 is a diagram generally illustrating an embodiment associated with business process variations 100, in accordance with aspects of the disclosure. FIG. 1 may relate to a scenario where variations are not completely different, nor completely identical. The embodiment may permit linking activities that are the same (e.g., in different process variations). Process variations may include activities that are linked with activities in other processes in a variety of ways, which may also be displayed in a variety of ways. In some examples, the business process variations desired to be viewed, compared, and/or managed, may be selected by name.

FIG. 1 shows one such example 100, with three process variations 105, 110, 115, compared side-by-side. In the example shown, the three process variations may all share a first activity 120, variation A 105 and variation C 115 may share a second activity 125; process A 105 and process B 110 may share a third activity 130; and both process C 115 may have an independent third activity 140 and process B may have an independent second activity 135.

When a change is made to one shared activity, the change may be optionally synced to other instances of that shared activity across process variations. Then, when a change is made to an activity that is linked to an activity in other variations, the option to accept the change can be presented. If the change is declined for a process variation, the shared activity may become unlinked from the other identical activities and become independent. This is one way that independent activities may be created (which may also be re-linked later).

In some examples described herein, shared activities need not be in the same order across process variations. For example, the same activity may be a first activity for one variation yet be a third activity in another variation. In some examples, the order or sequence of a shared activity within a process variation may be chosen before the activity is incorporated. Moreover, in some variations, a similar activity (but perhaps not identical activity) may be repeated throughout a process.

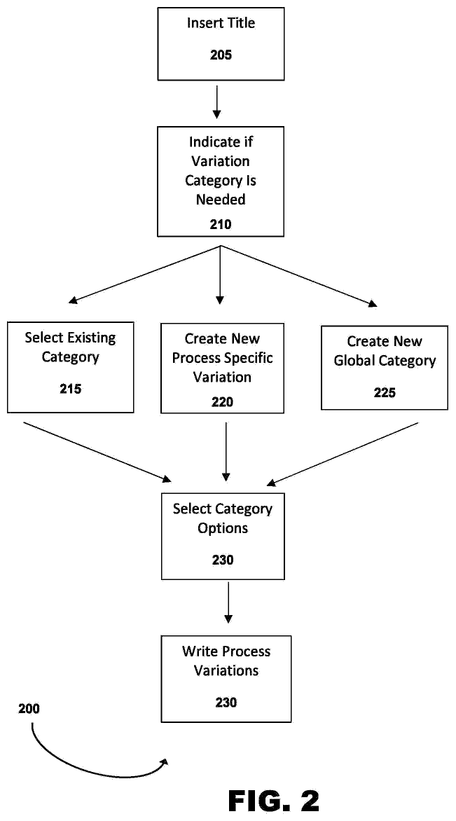

FIG. 2 is a functional flow diagram generally illustrating an embodiment associated with setting up 200 a business process variation, in accordance with aspects of the disclosure. Due in part to the complexity associated with managing the propagation process, current architectures and methods may not allow implementing changes from a standard, which are then propagated to variants, in a customized and controlled manner. Rather than automatically propagating changes from a “standard” through to all related processes, as explained above with regard to FIG. 1, optional propagation of features may occur through linked components. Thus, the embodiment of FIG. 1 may not necessarily involve a traditional “standard” process, but instead may involve an “umbrella” of related process variations having linked or independent activities.

New process variations may, in some embodiments, be set up using either an already-written variation as a template (which can then be edited) or from a “clean slate.” Additionally, in some embodiments, a “standard” variation may be created and called as such, with subsequent variations created using that standard as a template.

As shown in FIG. 2, in some embodiments, setting up a business process variation may include inserting a process variation title 205, indicating if a variation category is necessary 210, and then selecting one or more of an existing variation or global category 215, and/or a creating process-specific variation 220 (e.g. “ad hoc” variation names), and/or creating a new variation or global category 225 (and, potentially, process variation groups corresponding to that category). In some embodiments, only certain user types (e.g., “admins”) may be authorized to make one or more of the aforementioned selections (e.g., to create a new global category 225). In some embodiments, selecting a variation category may either trigger additional or less options 230 (e.g., sub-category options).

For example, when a pre-defined variation category is used or selected, in some examples, only pre-defined variation options in the global category may be selected (e.g., in some examples, only associated or required process variation options may be presented (and no others)). One existing variation category 225, for example, may correspond to office locations, which may then permit selection of offices. Next, certain process variations corresponding to the category may be selected for writing 235.

Moreover, when creating a variation category (e.g., a global variation category) 225, which options are needed for creating process variations may be selected. For example, if a process variation is not required for a Seattle office (because, e.g., the main or standard process is not used), then the Seattle option/process variation may not be created for this process.

In some examples, once a first process is selected or created for writing all or some of the activities for that process may be imported into a second process to write. Alternatively, a second process may be created from a blank canvas.

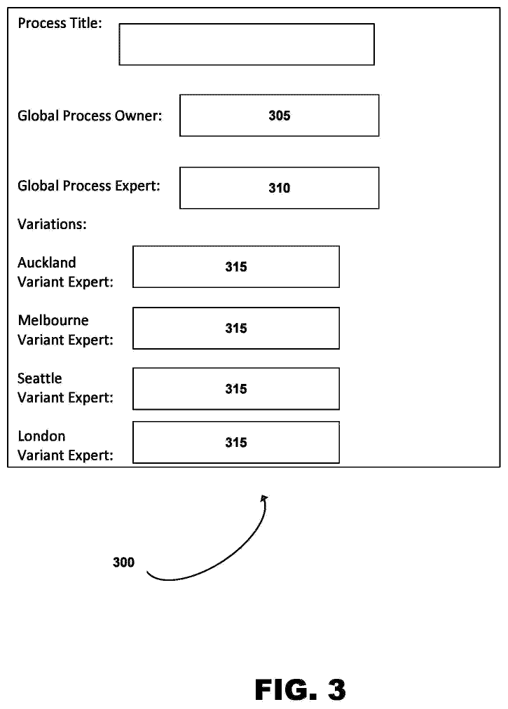

FIG. 3 is a block diagram generally illustrating an embodiment associated with assigning experts to business process variations, in accordance with aspects of the disclosure. In some embodiments (such as the embodiment described in FIG. 1), one or more experts (e.g., a global process owner 305, global process expert 310, variant expert 315, or stakeholder) may be assigned (usually at set up) to a business process variation or variations, or different offices using such variations. In some examples, multiple variation experts may exist, but only one global owner and one global expert. In some embodiments, such assigning may be implemented as a required field of an electronic form 300.

Such experts may assist in, among other things, managing and operating the business process variations. For example, such experts may be involved in process modeling, analysis, redesign, implementation, monitoring, defining performance measures and objectives, improvement projects, etc. In embodiments described herein, an assigned expert may have the ability to accept or decline a change to a business variation. In some embodiments, experts may be presented with the option of making an activity independent from other variations.

In some embodiments, other human actors (e.g., “process/variation editors”) in addition to experts may perform the activities of a business process on a day-to-day basis (potentially according to the standards and guidelines of the company). Such actors may generally be referred to as process participants and may also have roles, such as analysis and discovery of a process, redesign, implementation, etc. In some embodiments, such efforts may be coordinated or guided by an expert (as explained above), which may sometimes be leaders of teams of process participants (which may also sometimes have different roles within the teams).

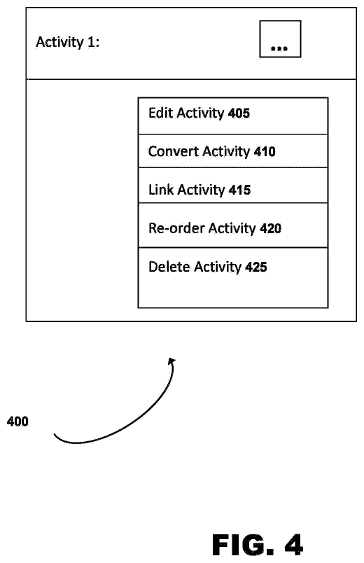

FIG. 4 is a block diagram generally illustrating an embodiment associated with controls for a business process variation, in accordance with aspects of the disclosure. Such settings 400 may allow editing 405 activities and converting 410 activities into tasks, or vice versa (i.e., converting tasks into activities). Such functions may allow a user to more simply and/or efficiently perform steps to set up and/or modify process variations.

In some embodiments, as soon as an activity is shared, and a record of the shared activity is created, such record may be edited by users of processes that incorporate the shared activity. Such a record may enable users to verify whether data associated with the shared activity (e.g., a shared activity definition) is up to date. In some embodiments, the record may not be edited (e.g., no new changes may be saved) while it is being edited by another user. Some examples (not shown) may also include a specific option of locking activities (in either a standard or variations), to prevent others from editing the activities, by stopping the creation of changes that propagate down into variations (and potentially cause confusion).

The settings may also allow linking 415 activities to other activities, which may involve overriding prior activities, and may also involve replacing the existing content with content from the newly linked activity. Some settings may also involve unlinking activities in the variations, for example, from all the other versions of the same shared activity in the other process variations (of from a shared activity status, and/or from an activity in a standard, for embodiments that use a standard), which may indicate that the changes should not be implemented to the variation featuring the unlinked activity. Such unlinking may assist, for instance, in managing changes, and with propagation management. For example, unlinking may indicate at what point (e.g., ordered activity) a business process variation diverges from another process variation (and in some embodiments, from a standard). In addition, an activity may also be reverted in a variation back to reflect a former variation version (or, in some embodiments, from a standard). In some embodiments, such reverting may be achieved by re-linking an activity in the variation (which was previously unlinked). In some examples, re-linking may be achieved, in accordance with other aspects of this disclosure, through dragging and dropping a desired shared activity from one process variation into the variation being edited, to re-incorporate tasks of the shared activity.

Some setting examples may also involve ordering or re-ordering 420 activities. Some embodiments of ordering may involve making activities parallel with a previous or next activity (e.g., or another process variation). Some setting examples may also include deleting 425 activities out of particular variations. Such reordering through unlinking may also have the benefit of not requiring re-ordering later.

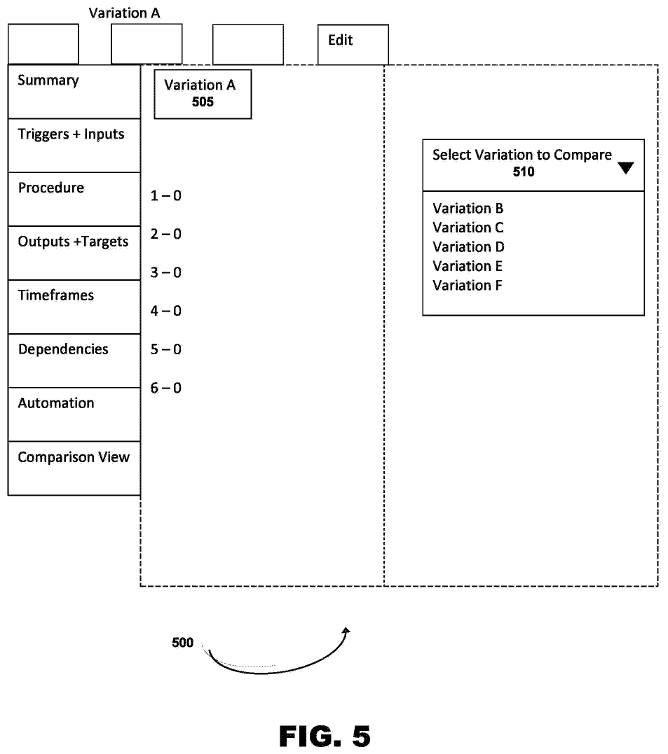

FIG. 5 is a block diagram generally illustrating an embodiment associated with comparing 500 business process variations, in accordance with aspects of the disclosure. In some embodiments, the editing mentioned above may include the ability to make changes to process variations (and in some embodiments, to a standard and/or variants thereof). In some embodiments, such changes may be implemented by comparing the variants to each other (or in some embodiments, by comparing the standard to the variants).

For example, in some embodiments, the editing may allow selecting two or more business process variations 505, 510 to compare. In some examples, the comparing may include a comparison view 500 showing two processes side-by-side (as shown with regard to FIG. 1), which may show differences between variations on one screen. In some embodiments of the comparison view, portions with (potentially minor) differences of the two or more versions of shared activities, respectively, may be highlighted. Other (potentially slight) differences within the same shared activity across different variations may include user assignment, notes, attachments, etc.

Such views and comparing, in combination with other aspects of the discovery, may provide greater visibility of the different process variations, e.g., of a particular business process within the organization. Such views and comparing, in combination with other aspects of the discovery, may also provide greater transparency and control around propagation of common data/activities between variations. In addition, comparing such process variations to each other may enable or facilitate managing and maintaining shared or common process data in process variations with more ease and less repetition.

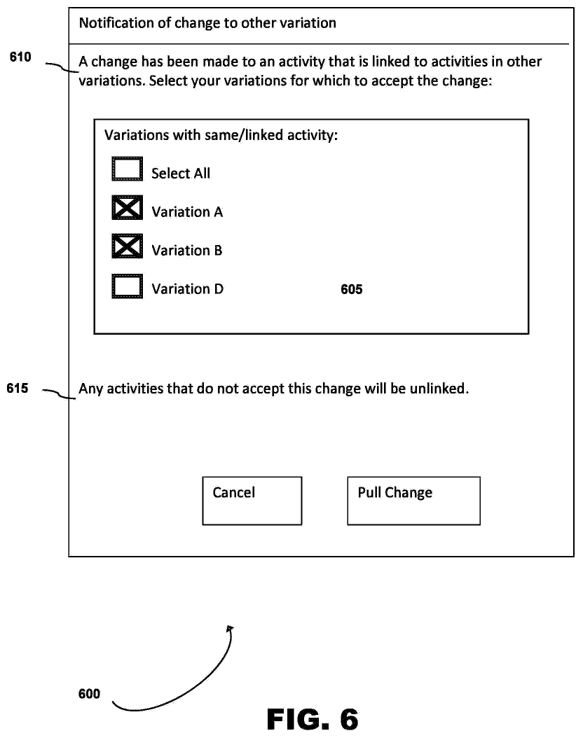

FIG. 6 is a block diagram generally illustrating an embodiment associated with linking 600 business process variations or features thereof, and incorporating features of a business process variation, in accordance with aspects of the disclosure. The comparing and propagating changes explained above, and other aspects of the disclosure, may facilitate management of common process data between process variations.

As mentioned elsewhere in this disclosure, at least one feature or component may be created—e.g., a shared activity—and placed into each variation that uses the feature. Relatedly, shared activities (or components thereof, in some embodiments) may be linked in different process variations 605 (and in some embodiments, to standards).

Some examples of the disclosure herein relate to selecting what changes are adopted or propagated into a process variation. When aspects related to the shared activity change, the shared activity may be updated. In some embodiments, this update may be shared with all other process variations that use the shared activity. In some embodiments, a variation expert assigned to each variation (using the shared activity) may be notified 610 of the change and asked if they wish to accept or reject the change. In some embodiments, a notification 610 may be sent based on a change being made to a shared activity. For example, a notification 610 may be sent to experts associated with business variations that include other linked activities (e.g., to every variation expert that uses the shared activity in their respective variation), indicating that a change was made, and requesting instructions on whether to accept or decline the change 615. Then, for example, each variation expert may determine the relevancy of the update to their variation, and whether to accept or decline the update.

In some embodiments, when a change is made to an activity that is linked to activities in other variations, variations 605 may be selected for which the change should be accepted. For example, in some embodiments, such changes may be approved or declined by each expert assigned to one or more other variations prior to such changes being accepted.

When a shared activity in one process variation is first adopted by another process variation, that second process variation may also inherit a role assignment, notes, and attachments from the first process variation. While a shared activity can be placed across multiple variations, aspects (e.g., an assigned role, notes, and attachments within the activity) of each instance of a shared activity can be different. For example, a process variation may have the same shared activity (e.g., with identical steps) as another process variation, but a user performing or otherwise associated with the activity may differ across different offices. In addition, in some embodiments, such aspects may then be modified in the second process variation and may continue to have common data (i.e., task data) of the shared activity. In some such embodiments, the role assignment, notes, and attachments may be modified in the second process variation without any changes to such data first occurring in the first process variation.

In some embodiments, an activity may be removed from a process variation that originally included the activity but is still required in another process variation. Thus, shared activities may be located (or not located) in any process variation.

In addition to a change to a shared activity itself, information indicating who made the change and why the change was made may also be provided (e.g., to variation experts). Such information may be helpful in deciding whether the change applies to a particular process variation and thus whether or to accept the change and continue using the shared activity, or component of the shared activity.

In some embodiments, activities in process variations where the change was declined may become unlinked from the shared activity.

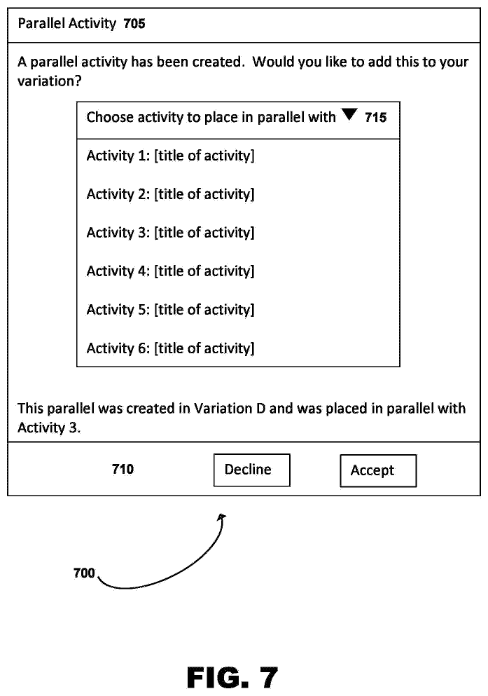

FIG. 7 is a block diagram generally illustrating an embodiment associated with parallel activities 700 of business process variations, in accordance with aspects of the disclosure. As mentioned in this disclosure, some embodiments may not center on standards, or may omit a standard entirely, and may instead compare process variations to each other. This may also have some beneficial effects, e.g., associated with propagating changes.

For example, greater transparency and control around propagation of common data/activities between variations may be facilitated. In some embodiments, only changes to activities that have been accepted from another process variation may involve continuing approvals (for additional changes to those accepted activities).

In some embodiments of comparing variations with other variations, an activity associated with or next to a shared activity may be referred to as a parallel activity 705, so that the two activities are placed “in parallel.” In some examples, the two activities in parallel may be treated as two shared activities with parallel settings managed in each variation.

Accordingly, a parallel activity 705 may be created, which may be optionally incorporated by other process variations (which, e.g., incorporate the shared activity). Stated differently, when created 705, parallel activities may propagate to other variations for review.

In some embodiments, variant experts for the other process variations may accept or decline 710 to incorporate the parallel activity. That is, in some examples, another variation expert may decide to accept the activity that is in parallel, but remove the parallel status, or make the activity parallel with a different activity (and potentially any activity) pertaining to the variation expert's assigned process variation. In some embodiments, a single expert (e.g., particular types of experts with greater roles) may accept parallel activity for several different process variations.

In some embodiments, at the time of choosing (or earlier) whether to accept the parallel activity, the location or locations 715 of the parallel activity (either in the originating/master process variation or in the other process variations into which the parallel activity may be incorporated) may be determined. For example, the location 715 of the parallel activity may refer to the originating process variation, and/or its ordered sequence (e.g., in relation to another step or activity in a process sequence) within that process and/or in the other process variations.

In some embodiments, the parallel activity may also be incorporated later (at a point in time after the change originating the parallel activity) into the other process variations. Similarly, the location of the parallel activity may be moved to another location within a process after the parallel activity has been incorporated.

In some embodiments, a parallel activity may remain linked to other instances of itself regardless of which activity it is in parallel with. In some embodiments, unlinking a parallel activity in a process variation from the parallel activity in the master may assist in managing the parallel activities.

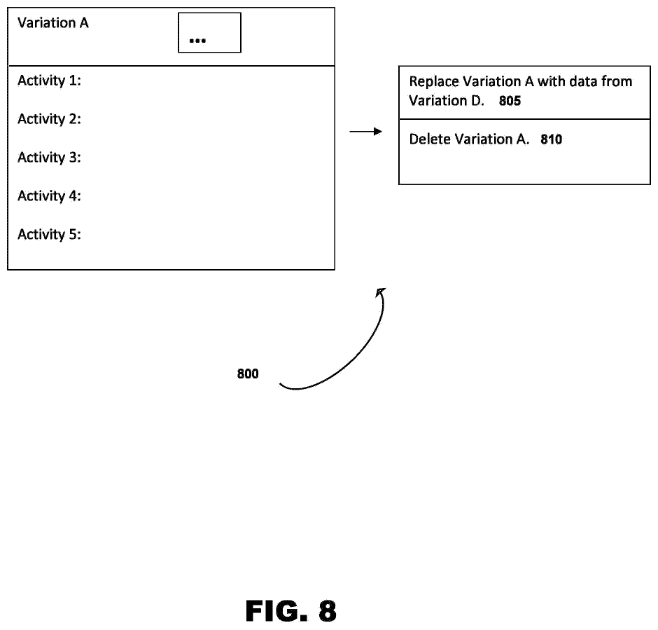

FIG. 8 is a block diagram generally illustrating an embodiment associated with deleting and replacing activities 800 of business process variations, in accordance with aspects of the disclosure. Some embodiments may involve replacing data 805 from one variation with data from another variation. In some examples, such replacing could involve overwriting some of the data (activities) 810 in a variation with data from another variation. In some examples, such replacing could involve overwriting all the data (activities) 810 in a variation with data from another variation—essentially deleting the variation. In some examples, such replacing and deleting may be achieved through dragging and dropping a selected shared activity into a variation, and then deleting the (potentially outdated) activity that is being replaced.

Similar to the relinking described above, some embodiments may also involve archiving deleted features (e.g., activities) or process variations. Such archived data or features may be recoverable, for example, within a certain timeframe. Some embodiments may permit creating new business process variations from an archived business process variation. Some process variations may be archived in different process categories.

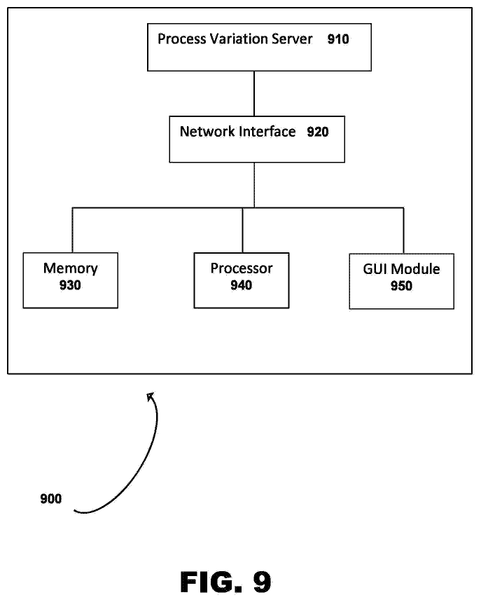

FIG. 9 is a block diagram generally illustrating an embodiment of an electronic device system 900 for implementing and managing changes to business process variations, in accordance with aspects of the disclosure. The electronic device 900 may be coupled to a process variation server 910 via a network interface 920. In one embodiment, the electronic device 900 may access the customization system residing in a process variation server or another server. In another embodiment, the customization system may reside on the electronic device 900. The electronic device 900 generally comprises a memory 930, a processor 940, and a graphical user interface module 950. The electronic device 900 is not limited to any particular configuration or system.

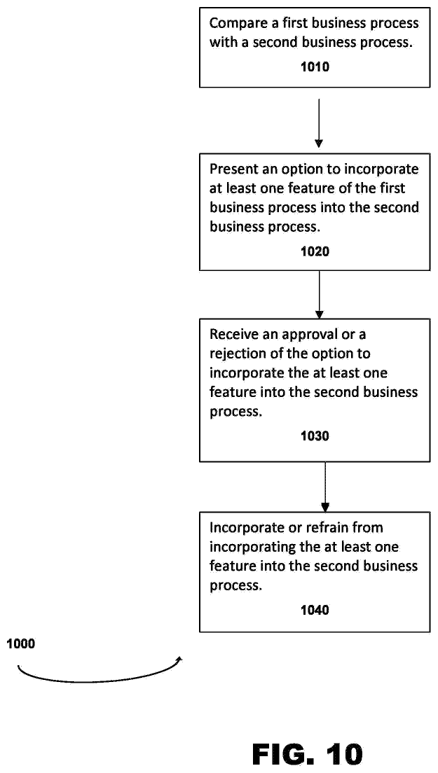

FIG. 10 is a flow diagram generally illustrating a method 1000 of selectively incorporating changes into business process variations, in accordance with aspects of the disclosure. In some embodiments, the method 1000 may include the step of comparing a first business process with a second business process 1010. In some examples, the first business process may include at least one feature omitted from the second business process.

The method 1000 may further include presenting, based at least in part on the comparing, an option to incorporate the at least one feature into the second business process 1020.

The method 1000 may also include receiving, based at least in part on the presenting, approval or rejection of the option to incorporate the at least one feature into the second business process 1030.

In addition, the method 1000 may include incorporating or refraining from incorporating, based at least in part on the receiving, the at least one feature into the second business process 1040.

Some embodiments described in this disclosure may also include a task-engine service that provides centralized management and routing of tasks; including processing, assignment, collection of supplemental data, governance, status, and syncing across all related systems. It may also provide application programming interfaces (“APIs”) through which a user may connect to other task-interaction providers such as Skype, Slack, Salesforce, SharePoint, mobile, application, bots, emails, web forms, etc. The disclosed task-engine service may generate the user interface for each task-interaction provider, and when the user completes the task in one place, it will be automatically updated in all other places in which the task exists. In terms of how this is surfaced: the workflow administrator, by tenant, may configure globally which integrations can be used for tasks; the workflow designer, at a workflow level, may configure where tasks will be surfaced; and the end user may also configure its preferences to determine where tasks may be completed.

As used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that may be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all embodiments of this application including, but not limited to, steps in disclosed methods. Thus, if there are a variety of additional steps that may be performed it is understood that each of these additional steps may be performed with any specific embodiment or combination of embodiments of the disclosed methods.

Embodiments of the systems and methods are described with reference to schematic diagrams, block diagrams, and flowchart illustrations of methods, systems, apparatuses and computer program products. It will be understood that each block of the block diagrams, schematic diagrams, and flowchart illustrations, and combinations of blocks in the block diagrams, schematic diagrams, and flowchart illustrations, respectively, may be implemented by computer program instructions. These computer program instructions may be loaded onto a general-purpose computer, special purpose computer, or other programmable data processing apparatus to produce a machine, such that the instructions which execute on the computer or other programmable data processing apparatus create a means for implementing the functions specified in the flowchart block or blocks.

Other embodiments may comprise overlay features demonstrating relationships between one more steps, active users, previous users, missing steps, errors in the workflow, analytical data from use of the workflow, future use of the workflow, and other data related to the workflow, users, or the relationship between the workflow and users.

These and other features, and characteristics of the present technology, as well as the methods of operation and functions of the related elements of structure and the combination of parts and economies of manufacture, will become more apparent upon consideration of the description herein and the appended claims with reference to the accompanying drawings, all of which form a part of this specification, wherein reference numerals designate corresponding parts in the various figures. It is to be expressly understood, however, that the drawings are for the purpose of illustration and description only and are not intended as a definition of the limits of the disclosure.

In addition, the various illustrative logical blocks, modules, and circuits described in connection with certain embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, system-on-a-chip, or state machine. A processor may also be implemented as a combination of computing devices, e.g., a combination of a DSP and a microprocessor, a plurality of microprocessors, one or more microprocessors in conjunction with a DSP core, or any other such configuration.

Operational embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, a DVD disk, or any other form of storage medium known in the art. An exemplary storage medium is coupled to the processor such the processor may read information from, and write information to, the storage medium. In the alternative, the storage medium may be integral to the processor. The processor and the storage medium may reside in an ASIC or may reside as discrete components in another device.

Furthermore, the one or more versions may be implemented as a method, apparatus, or article of manufacture using standard programming and/or engineering techniques to produce software, firmware, hardware, or any combination thereof to control a computer to implement the disclosed embodiments. Non-transitory computer readable media may include but is not limited to magnetic storage devices (e.g., hard disk, floppy disk, magnetic strips), optical disks (e.g., compact disk (CD), digital versatile disk (DVD)), smart cards, and flash memory devices (e.g., card, stick). Those skilled in the art will recognize many modifications may be made to this configuration without departing from the scope of the disclosed embodiments.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order; it is in no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

What is claimed is:

1. A computing device comprising:
a processor;
a memory; and
a non-transitory, computer-readable medium operably coupled to the processor, the computer-readable medium having computer-readable instructions stored thereon that, when executed by the processor, cause the computing device to,
compare a first business process with a second business process, wherein the first business process includes at least one feature omitted from the second business process;
present, based at least in part on the comparing, an option to incorporate the at least one feature into the second business process;
receive, based at least in part on the presenting, approval or rejection of the option to incorporate the at least one feature into the second business process; and
incorporate or refrain from incorporating, based at least in part on the receiving, the at least one feature into the second business process.

2. The computing device of claim 1, wherein the computer-readable instructions further cause the computing device to:
present the option to incorporate to an expert associated with the second business process; and
receive the approval or the rejection from the expert.

3. The computing device of claim 1, wherein the computer-readable instructions causing the computing device to incorporate further cause the computing device to:
change an earlier feature of the second business process.

4. The computing device of claim 3, wherein the computer-readable instructions causing the computing device to change the earlier feature further cause the computing device to:
archive the changed earlier feature; and
track the incorporated at least one feature.

5. The method of claim 4, further comprising:
unincorporating, based at least in part on an input, the incorporated at least one feature; and
restoring, based at least in part on the archiving, the changed earlier feature to be incorporated into the second business process.

6. The computing device of claim 3, wherein the at least one feature comprises an activity, and wherein the computer-readable instructions causing the computing device to change the earlier feature further cause the computing device to:
delete and replace the earlier feature with the activity.

7. The computing device of claim 6, wherein the computer-readable instructions further cause the computing device to:
mark, based at least in part on the at least one input, the activity as shared between the first business process and the second business process.

8. The computing device of claim 7, wherein the computer-readable instructions causing the computing device to mark further cause the computing device to:
trigger the marking based the activity being dragged and dropped within visual representations of the at least two processes in a visual graphical interface.

9. The computing device of claim 1, wherein the computer-readable instructions further cause the computing device to:
link the at least one feature of the first business process to the incorporated at least one feature of the second business process.

10. The computing device of claim 9, wherein the computer-readable instructions causing the computing device to link further cause the computing device to:
unlink, based on an input, the at least one feature from the at least one second business process feature.

11. A method for selectively incorporating changes into business processes, the method comprising:
comparing a first business process with a second business process, wherein the first business process includes at least one feature omitted from the second business process;
presenting, based at least in part on the comparing, an option to incorporate the at least one feature into the second business process;
receiving, based at least in part on the presenting, approval or rejection of the option to incorporate the at least one feature into the second business process; and
incorporating or refraining from incorporating, based at least in part on the receiving, the at least one feature into the second business process.

12. The method of claim 11, wherein the presenting is to an expert associated with the second business process, and wherein the receiving is from the expert.

13. The method of claim 11, wherein the step of incorporating further comprises changing an earlier feature of the second business process.

14. The method of claim 13, wherein the at least one feature comprises an activity, and the changing comprises deleting and replacing the earlier feature with the activity.

15. The method of claim 14, further comprising:
marking, based at least in part on the at least one input, the activity as shared.

16. The method of claim 15, wherein the at least one input comprises the activity being dragged and dropped within visual representations of the at least two processes in a visual graphical interface.

17. The method of claim 15, wherein the step of marking further comprises:
linking the at least one feature to the incorporated at least one second business process feature.

18. A non-transitory, computer-readable medium having stored thereon computer-readable instructions that when executed by a computing device cause the computing device to:
compare a first business process with a second business process, wherein the first business process includes at least one feature omitted from the second business process;
present, based at least in part on the comparing, an option to incorporate the at least one feature into the second business process;
receive, based at least in part on the presenting, approval or rejection of the option to incorporate the at least one feature into the second business process; and
incorporate or refrain from incorporating, based at least in part on the receiving, the at least one feature into the second business process.

19. The non-transitory, computer-readable medium of claim 18, wherein the computer-readable instructions further cause the computing device to:
change an earlier feature of the second business process.

20. The non-transitory, computer-readable medium of claim 19, wherein the at least one feature comprises an activity, and wherein the computer-readable instructions further cause the computing device to:
mark, based at least in part on the at least one input, the activity as shared between the first business process and the second business process.
